(19) United States
(12) Patent Application Publication
(10) Pub. No.: US 2013/0215253 A1
(43) Pub. Date: Aug. 22, 2013

(54) UNDERWATER LENS MOUNT SYSTEM FOR UNDERWATER MOTION PICTURE CAMERAS

(71) Applicant: Pawel Achtel, Coles Bay (AU)

(72) Inventor: Pawel Achtel, Coles Bay (AU)

(21) Appl. No.: 13/398,722

(22) Filed: Feb. 16, 2012

(51) Int. Cl. G03B 17/08; H04N 7/18

(52) U.S. Cl. 348/81; 396/25; 348/E07.085

(57) ABSTRACT

An underwater interchangeable lens mount system with a lens mount integrated within an underwater housing for a motion picture camera. The lens mount includes a first portion, a second portion and a third portion. The interchangeable lens mount is embedded in a watertight housing which provides more flexibility in using other types of lens mounts and avoids distortion in underwater photography due to a lens port. The interchangeable lens mount is designed to mount a submersible lens specifically designed for under water use. The interchangeable lens mount is adaptable to change with a wide variety of submersible lenses and acts as a camera's entire lens mount normally contained within a watertight housing. Two interchangeable lens mounts and two submersible lenses allow the motion picture cameras to make stereoscopic configurations.

### CROSS-REFERENCE TO RELATED APPLICATION

Not Applicable

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The invention relates to underwater lens mounts, and more particularly, to an underwater lens mount integrated within an underwater housing for a motion picture camera.

A lens mount is a type of attachment that connects the lens onto the body of the camera. An underwater lens mount may be a screw-threaded type, a friction lock type or a bayonet-type. Bayonet type lens mounts are the most popular and are considered more reliable.

At present, a common solution for taking photographs underwater would be to place a camera and lens designed to work in air inside of an underwater housing unit containing a flat or dome port. The problem with a flat port is that a flat port is not able to correct the distortion produced by the differences between the indexes of refraction of light in air and in water. A dome port, on the other hand, can eliminate refraction, radial distortion and axial and chromatic aberration. However, dome ports only reduce aberrations and distortions to an extent. They still suffer from image plane curvature, which results in corners of the image not being sharp. They also introduce chromatic aberrations, albeit not to the same degree as flat ports.

Known is U.S. Pat. No 7,369,760 issued to Waterford on May 6, 2008, which describes a shallow-water submersible splash housing which is capable of sealing and protecting a camera from an underwater or otherwise harsh environment. The shallow water submersible splash housing includes an elastomeric transparent enclosure having front and rear ends, a front port assembly closing the front end of the enclosure for supporting the camera and a window provided in the front port assembly. A back plate assembly closes the rear end of the enclosure. The front port assembly may also contain iris rods to facilitate the mounting of the camera in the enclosure and interior air flow nozzles to maintain positive air pressure in the enclosure as well as prevent fogging of the window in the front port assembly.

Similarly, U.S. Pat. No. 5,897,229 issued to Kawakami on Apr. 27, 1999, describes a lens mount for a camera for mounting an interchangeable lens unit. The camera includes a casing, a chassis provided in the interior of the casing; a button on the casing, a lock mechanism (actuated in response to the button) which locks the lens unit on the lens mount; a sensor unit which detects whether the lock mechanism is activated or not. The sensor unit is located in the chassis. The camera is provided with an actuator that moves in response to the lock mechanism, which penetrates a panel of the chassis so that the sensor unit is activated.

U.S. Pat. No. 5,570,153 issued to Shono on Oct. 29, 1996 defines a combination of camera bodies and detachable lenses including a lens-side and body-side bayonet mounting structure on two format types of lens and camera bodies. This allows the mounting of a larger format lens to a smaller format body, and to preclude the mounting of a smaller format lens to a larger format body. The body-side mounts have mounting gaps of predetermined sizes; and the lens-side mounts have mounting members of predetermined sizes to fit into the mounting gaps. The larger format lens-side mounting member is sized to fit into both smaller and larger format mounting gaps; and the smaller lens-side mounting member is sized to fit into only the smaller format mounting gap. Common reference surfaces are provided to all of the mounts to position the lens in the radial and axial directions.

None of the above lens mounting structures or underwater housing allows a photographer to take perfect images underwater without chromatic aberration and/or image distortion from a port. None of these structures permit an entire camera lens mount to be replaced for underwater photography. For underwater photography, the current art requires the use of a lens adaptor for an existing lens mount already built into the camera.

There is a need for an alternate solution that does not require a lens adapter or port. The present invention provides a solution in the form of an interchangeable lens mount system that would be able to mount a variety of interchangeable lens units which can be used under water. Such a needed system would provide an interchangeable lens mount that would allow a photographer to take sharp and perfect images without image distortion and chromatic aberration resulting from a port. Without image distortion and chromatic aberration, a lens adapter is not needed. The interchangeable lens mount system consists of a lens mount lens mount which is integrated within an underwater housing unit, thereby doing away with a port.

### SUMMARY

The present invention is an underwater lens mount that is a part of an underwater housing. The underwater lens mount is an interchangeable lens mount which includes a first portion, a second portion and a third portion. The interchangeable lens mount is designed to mount an interchangeable lens unit. A submersible lens is specifically designed to be used in water as the interchangeable lens unit. The interchangeable lens mount is embedded in the watertight housing which avoids the problem of distortion (as a lens need not be placed behind a port) and provides more flexibility in underwater photography. The interchangeable lens mount is adaptable to change with a wide variety of lenses specifically designed for underwater use and acts as a camera's entire lens mount normally contained within a watertight housing. The submersible lens features an o-ring which seals against a circular opening in the interchangeable lens mount integrated in the watertight housing. The submersible lens is retained inside the interchangeable lens mount with a bayonet type fitting.

The lens mount is a watertight lens mount system that is adaptable to accept the submersible lens. It includes a plurality of camera mounting holes to connect the lens mount to the motion picture camera. The interchangeable lens mount is connected to the motion picture camera employing a plurality of connecting means. It is part of the watertight housing and allows for direct connection with the submersible lens.

The lens mount is designed to attach directly to the submersible lens without a port so that image can be clearer and free from unwanted distortions. The interchangeable lens mount is able to protect a plurality of camera components such as a digital imaging camera and an imaging sensor. Two interchangeable lens mounts and two submersible lenses allow a motion picture camera to take stereoscopic configurations. The stereoscopic 3D configuration utilizes two cameras and two lenses positioned side-by-side, yielding an additional advantage of being able to achieve relatively small inter-axial distance between two optical axes.

Although particular embodiments of the present invention have been described in the foregoing description, it is to be understood that the present invention is not to be limited to just the embodiments disclosed, but that they are capable of numerous rearrangements, modifications and substitutions without departing from the description herein.

### BRIEF DESCRIPTION OF THE FIGURES

FIG. 1 is a perspective view of an interchangeable lens mount.

FIG. 2 shows a connection between the interchangeable lens mount with a submersible lens.

FIG. 3 is a front view of a motion picture camera in which the interchangeable lens mount is mounted onto the camera.

FIG. 4 is a perspective view of a watertight housing in which the interchangeable lens mount is integrated within.

FIG. 5 shows a submersible lens attached the interchangeable lens mount of the watertight housing.

FIG. 6 shows the placement of the motion picture camera contained within the watertight housing and behind the interchangeable lens mount.

FIG. 7A shows a first portion of the interchangeable lens mount.

FIGS. 7-B1 and 7-B2 show a second portion of the interchangeable lens mount.

FIG. 7C shows a third portion of the interchangeable lens mount.

FIG. 8 shows a wall of the interchangeable lens mount.

FIG. 9 shows the submersible lens with an o-ring.

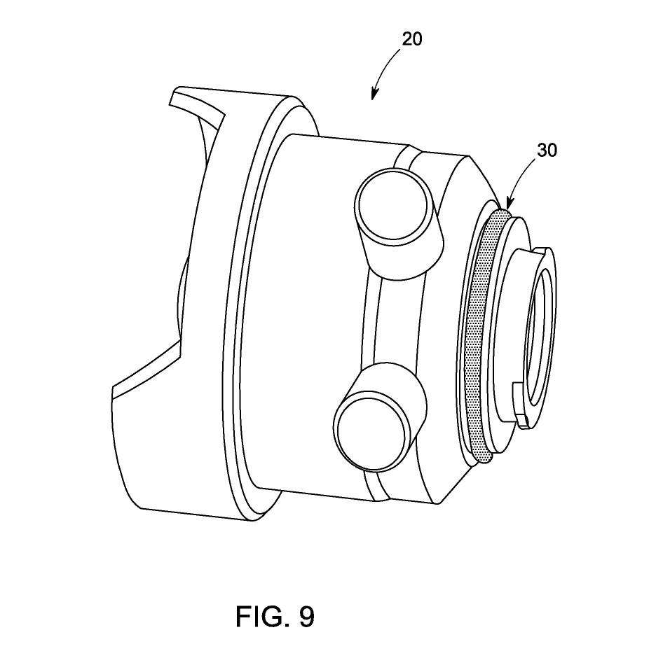

### REFERENCE NUMERALS

10 . . . interchangeable lens mount
12 . . . first portion
14 . . . second portion
16 . . . third portion
18 . . . plurality of mounting holes
20 . . . submersible lens
22 . . . motion picture camera
24 . . . imaging sensor
26 . . . watertight housing
28 . . . circular opening
29 . . . wall of the watertight housing
30 . . . o-ring
32 . . . bayonet retaining
50 . . . connection between the interchangeable lens mount with a submersible lens
60 . . . front view of the motion picture camera in which the interchangeable lens mount is mounted on to the camera

### DETAILED DESCRIPTION

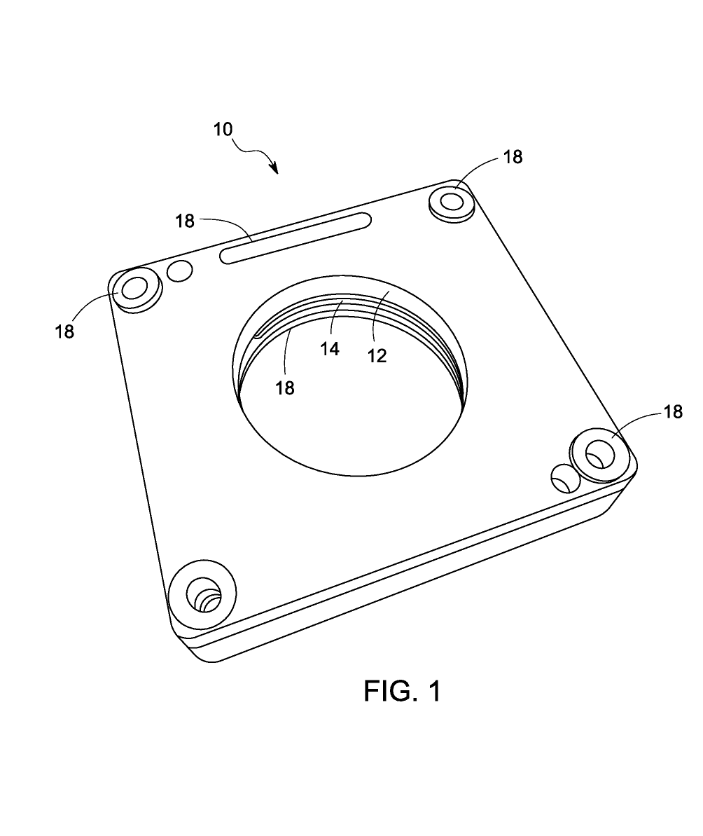

FIG. 1 is a perspective view of an interchangeable lens mount 10. The interchangeable lens mount 10 includes a first portion 12, a second portion 14 and a third portion 16. The interchangeable lens mount 10 is designed to mount a variety of interchangeable lens units (“submersible lenses”) (not shown) which is specifically designed to be used under water. The interchangeable lens mount acts as a motion picture camera's entire lens mount which is normally contained within a watertight housing (not shown) along with the camera (not shown). The interchangeable lens mount 10 is a watertight lens mount which includes a plurality of mounting holes 18 that connect to a camera. The interchangeable lens mount 10 is connected to the camera employing a plurality of connecting means (not shown). The interchangeable lens mount 10 is an integral part of the watertight housing (not shown).

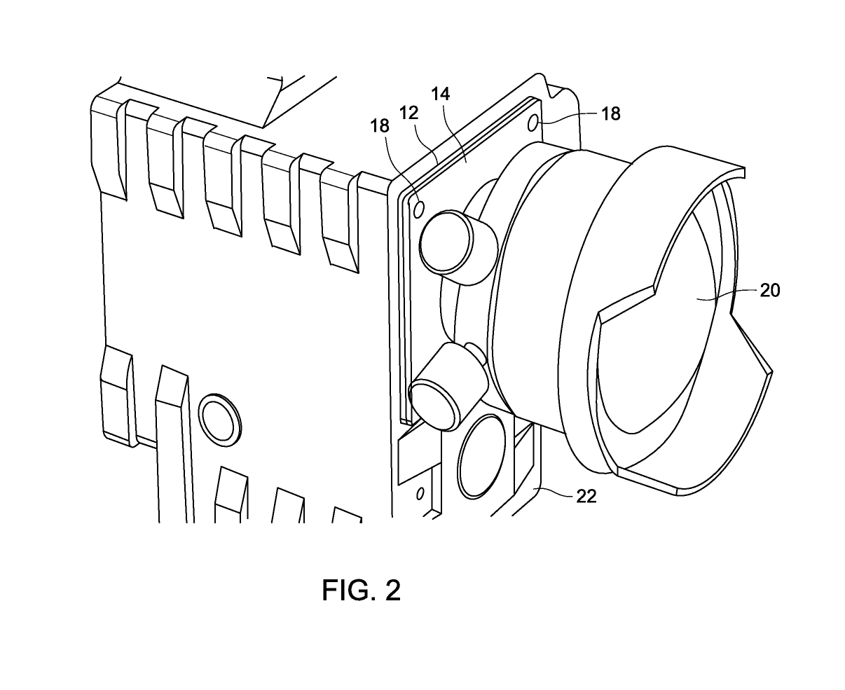

FIG. 2 shows a connection 50 between the interchangeable lens mount 10, a submersible lens 20, and a motion picture camera 22, without the water tight housing 26. The lens mount 10 is designed to attach the submersible lens 20 that can take clear images in water. The submersible lens 20 is in direct contact with water. The interchangeable lens mount 10 is able to protect a plurality of camera components such as a digital imaging camera and an imaging sensor from contact with water by the means of a third portion 16 of the mount (not shown).

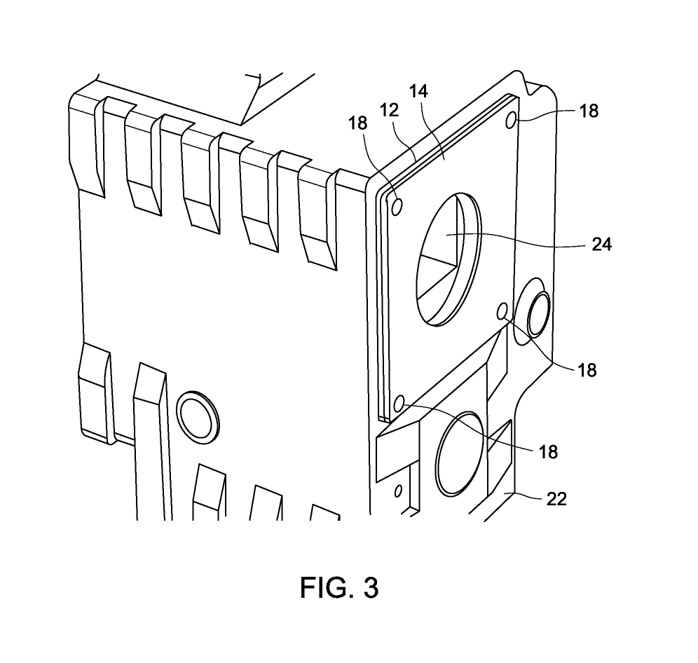

FIG. 3 is a front view 60 of a motion picture camera 22 on to which the interchangeable lens mount 10 is mounted. The interchangeable lens mount 10 is a part of the watertight housing (not shown) and the interchangeable lens mount 10 allows for a direct connection with the submersible lens 20 instead of connecting to a normal lens. The motion picture camera 22 can be a digital imaging camera, including an imaging sensor 24. The interchangeable lens mount 10 and the submersible lens 20 allow the motion picture camera 22 to achieve stereoscopic 3D configurations. The stereoscopic 3D configuration utilizes two cameras and two lenses positioned side-by-side yielding an additional advantage of being able to achieve relatively small inter-axial distance between the two optical axes.

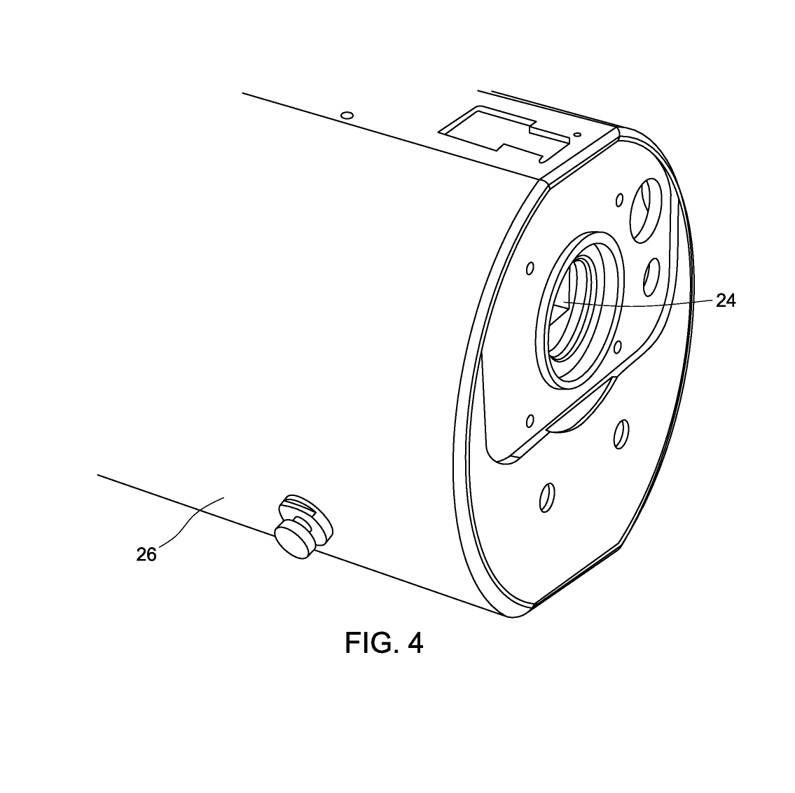

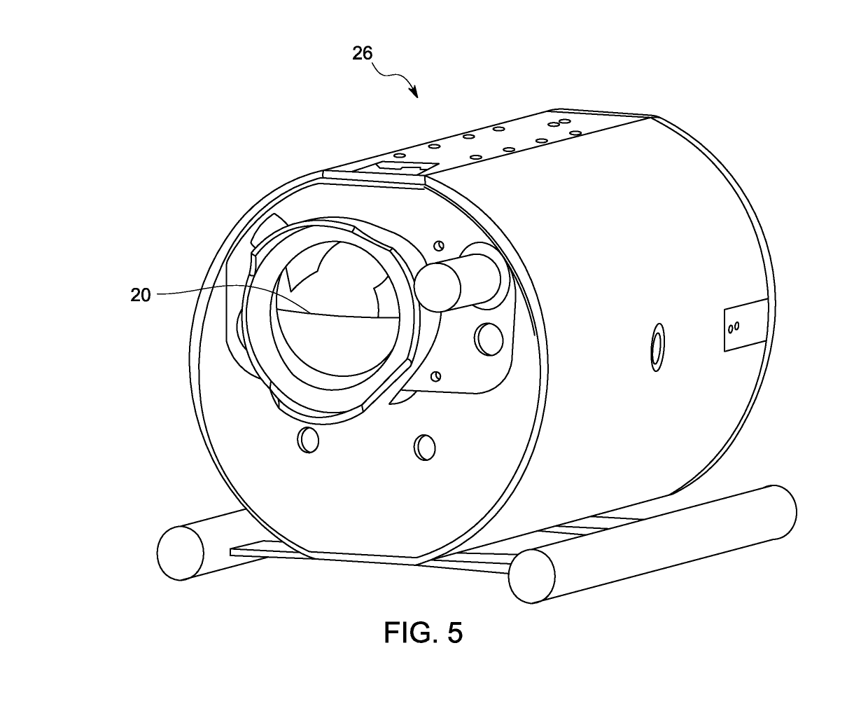

FIG. 4 is a perspective view of a watertight housing 26 in which the interchangeable lens mount 10 is integrated. The entire system is watertight when the submersible lens 20 is attached to the interchangeable lens mount 10 which is attached to the watertight housing 26. The interchangeable lens mount 10 is in direct contact and integrated with the watertight housing 26 from inside the watertight housing. The motion picture camera 22 is contained within the housing along with the interchangeable lens mount, while the submersible lens 20 is outside the housing 26 (FIG. 5) and attached to the interchangeable lens mount 10 through a bayonet-type attachment. This arrangement provides more flexibility and avoids distortion in underwater photography without the need for a lens adapter.

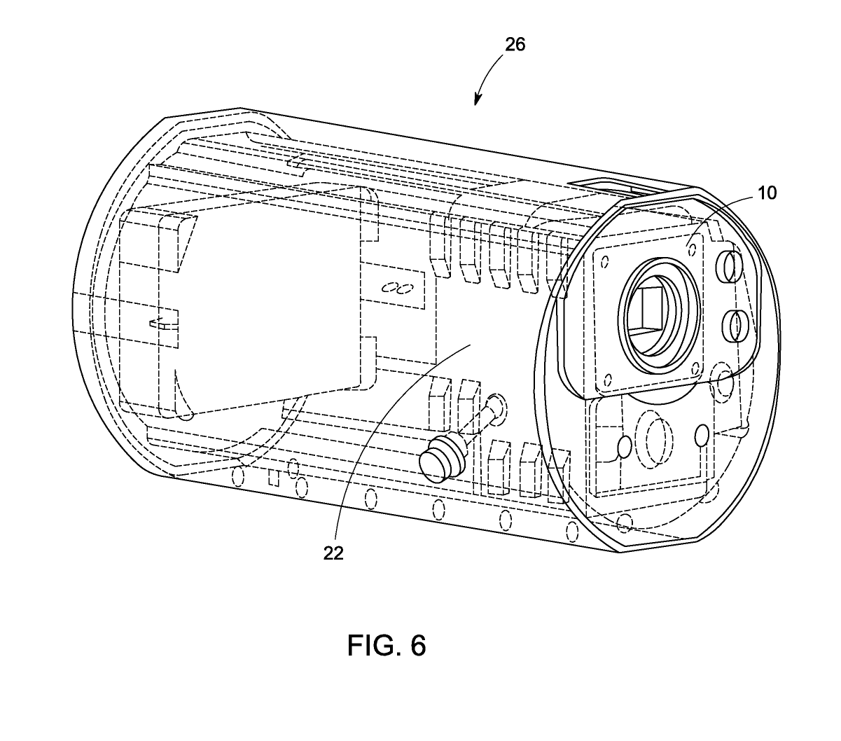

FIG. 5 shows the submersible lens 20 attached to the interchangeable lens mount 10 of the watertight housing 26. The submersible lens 20 is sealed against the wall of the interchangeable lens mount 10 with an o-ring 30 which makes the connection between the submersible lens 20 and the interchangeable lens mount 10 watertight. The submersible lens 20 is retained inside the interchangeable lens mount 10 with a bayonet type fitting. The interchangeable lens mount 10 is an integral part of the watertight housing 26, and without a lens port, is able to avoid distortion and provide more flexibility in underwater photography. FIG. 6 shows the arrangements of the motion picture camera 22 incorporated within the watertight housing 26 and behind the interchangeable lens mount 10. The interchangeable lens mount 10 is shown affixed to the inside of the watertight housing 26. The submersible lens is not shown.

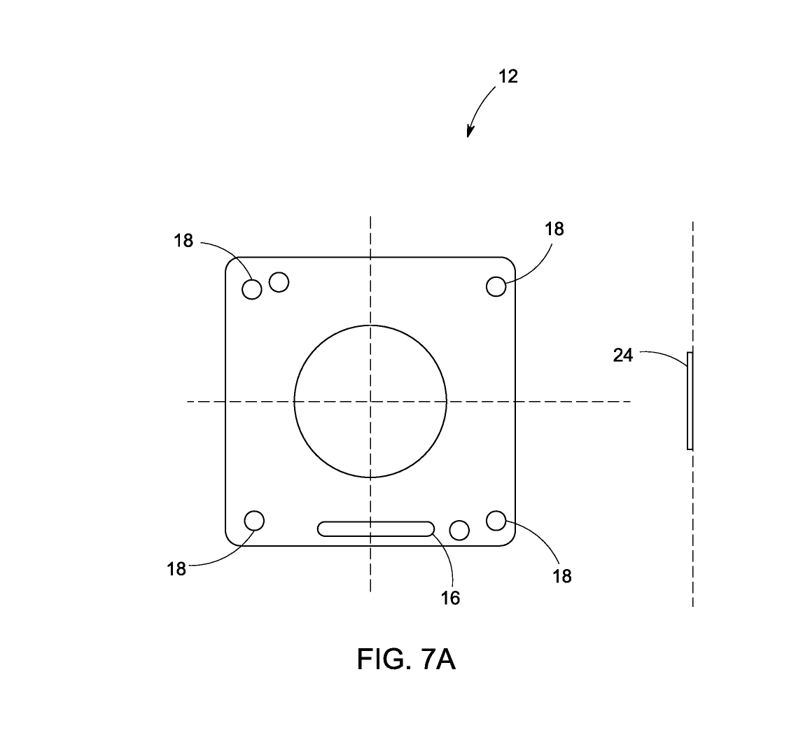

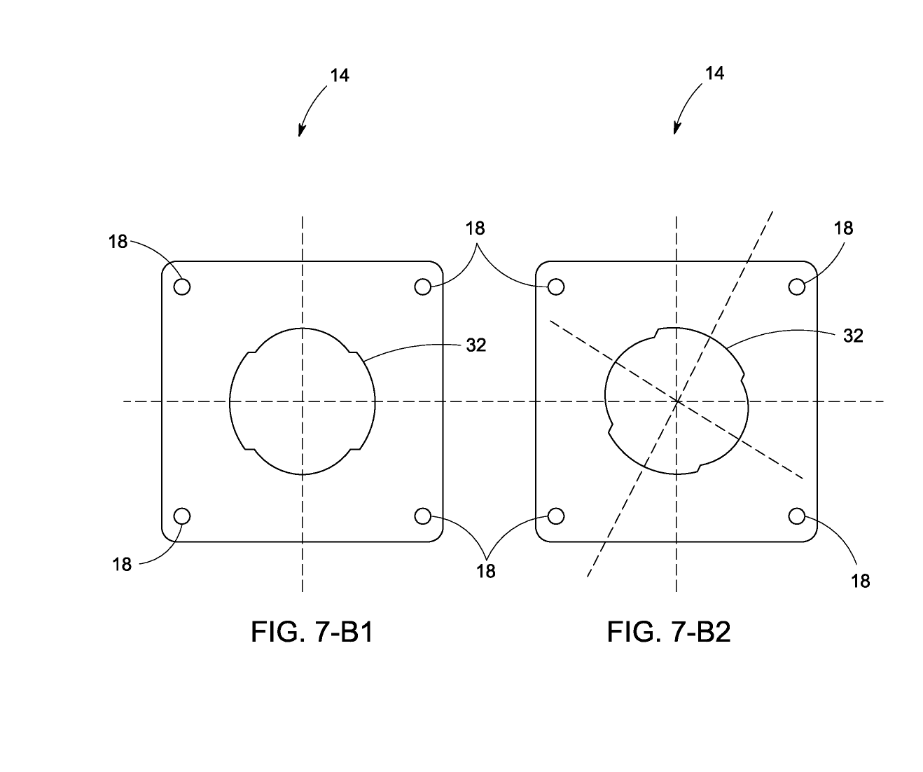

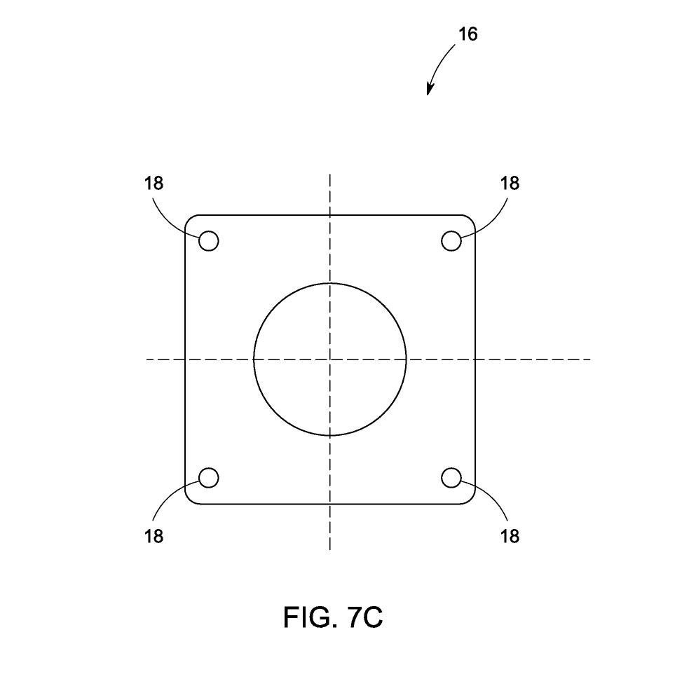

FIG. 7A shows the first portion 12 of the interchangeable lens mount 10. The first portion 12 faces the motion picture camera 22. The thickness of the first portion 12 determines the back focal distance of the submersible lens 20. The first portion 12 has a diameter of about 41.2 millimeter (mm). The plurality of camera mounting holes 18 is present in the interchangeable lens mount 10 to connect with the motion picture camera 22.

FIGS. 7-B1 and 7-B2 show the second portion 14 of the interchangeable lens mount 10. The second portion 14 is to protect the lens 20 by making the lens 20 bayonet retaining 32 and is done by adjusting the second portion 14 of the interchangeable lens mount 10 in a 60 degree angle. The second portion 14 can be adjusted in two ways to make the lens 20 bayonet retaining. The thickness of the second portion 14 is approximately 1.8 mm. FIG. 7C shows a third portion 16 of the interchangeable lens mount 10 having a diameter of about 40.6 mm that is either a separate plate or constitutes the front wall of the underwater housing 26.

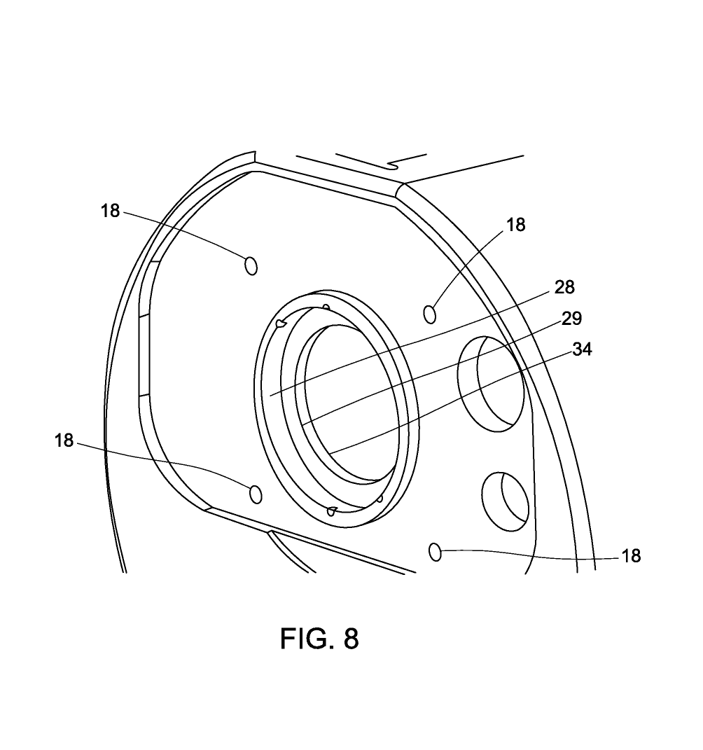

FIG. 8 shows the watertight housing 26 without the submersible lens 20 and motion picture camera 22. The watertight housing also feature a plurality of mounting holes 18 that correspond to the plurality of mounting holes 18 of the interchangeable lens mount 10. The interchangeable lens mount 10 is fastened to the watertight housing 26 through their plurality of mounting holes 18 with fasteners (not shown). The submersible lens 20 is fastened to the lens mount 10 through a circular opening 28 of the watertight housing 26. A wall 29 of the watertight housing 26 provides a stopping point for the submersible lens 20 and a sealing point for the o-ring 30.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Although preferred embodiments of the present invention have been shown and described, various modifications and substitutions may be made thereto without departing from the spirit and scope of the invention. Accordingly, it is to be understood that the present invention has been described by way of illustration and not limitation.

Any element in a claim that does not explicitly state “means for” performing a specified function, or “step for” performing a specific function, is not to be interpreted as a “means” or “step” clause as specified in 35 U.S.C. §112, paragraph 6. In particular, the use of “step of” in the claims herein is not intended to invoke the provisions of 35 U.S.C. §112, paragraph 6.

What is claimed is:

1. An Interchangeable lens mount system for underwater photography comprising:
an interchangeable lens mount attachable to a watertight camera housing; the watertight camera housing having a central opening corresponding to a central opening of the interchangeable lens mount; the watertight camera housing further comprising a plurality of mounting holes that correspond to a plurality of mounting holes of the interchangeable lens mount;
a submersible lens specifically designed for underwater use and attachable to the watertight camera housing through the interchangeable lens mount; and
a camera contained within the housing and attachable to a back side of the interchangeable lens mount;
wherein the attachment of the submersible lens to the interchangeable lens mount, and the attachment of the interchangeable lens mount to the watertight housing creates a watertight environment that protects the camera from water exposure and allows a camera to take clear images without the use of a port.

2. The interchangeable lens mount system of claim 1, wherein the interchangeable lens mount has a bayonet-type attachment means to accommodate a submersible lens.

3. The interchangeable lens mount system of claim 1, wherein the interchangeable lens mount comprises a first portion, a second portion, and a third portion.

4. The interchangeable lens mount system of claim 3, wherein the first portion dictates the back focal distance of the submersible lens based on its thickness.

5. The interchangeable lens mount system of claim 3, wherein the second portion is bayonet-retaining.

6. The interchangeable lens mount system of claim 3, wherein the third portion protects camera components from contact with water.

7. The interchangeable lens mount system of claim 1, wherein the interchangeable lens mount is attached to the watertight camera housing with fasteners through the plurality of mounting holes of the watertight camera housing and the plurality of mounting holes of the interchangeable lens mount.

8. The interchangeable lens mount system of claim 1, wherein the submersible lens comprises an o-ring that seals against a wall of the watertight camera housing.

9. The interchangeable lens mount system of claim 1, wherein the submersible lens is retained inside the interchangeable lens mount with a bayonet type fitting.

10. The interchangeable lens mount system of claim 1, wherein the camera is a motion picture camera or a digital imaging camera, including an imaging sensor.

11. The interchangeable lens mount system of claim 1, wherein the interchangeable lens mount system can achieve stereoscopic 3D configurations underwater when used in conjunction with two cameras and two lenses.

12. An interchangeable lens mount comprising a first portion, a second portion, and a third portion, wherein the first portion dictates the back focal distance of a submersible lens based on its thickness, the second portion is bayonet-retaining, and the third portion protects camera components from contact with water, further comprising a central opening through the first, second, and third portions, and a plurality of mounting holes through the first, second, and third portions.
